(19) United States
(12) Patent Application Publication
(10) Pub. No.: US 2015/0357660 A1
(43) Pub. Date: Dec. 10, 2015

(54) PINHOLE DETECTION SYSTEM OF FUEL CELL

(71) Applicants: Kia Motors Corporation, Seoul (KR); Hyundai Motor Company, Seoul (KR)

(72) Inventors: Sang Yeoul Ahn, Seoul (KR); Keun Je Lee, Yongin (KR); Sang Hyun Cho, Hwaseong (KR); Jea Suk Park, Suwon Gyunggi-do (KR); Sung Keun Lee, Suwon (KR); Byung Ki Ahn, Seongnam (KR); Tae Won Lim, Seoul (KR)

(73) Assignees: KIA MOTORS CORPORATION, Seoul (KR); HYUNDAI MOTOR COMPANY, Seoul (KR)

(21) Appl. No.: 14/100,900

(22) Filed: Aug. 26, 2015

Related U.S. Application Data
(63) Continuation-in-part of application No. 12/815,320, filed on Jun. 14, 2010, now abandoned.

(30) Foreign Application Priority Data
Nov. 26, 2009 (KR) 10-2009-0115265

(51) Int. Cl. H01M 8/04; G01N 23/04

(52) U.S. Cl. CPC H01M 8/04671; G01N 23/046

(57) ABSTRACT

The present invention features a pinhole detection system of a fuel cell that preferably includes a stage on which a fuel cell element unit is disposed to be detected, a drive portion that is configured to move the stage so as to rotate the fuel cell element unit, a X-ray source that is disposed at one side of the stage to apply X-ray to the fuel cell element unit that rotates, an image detector that detects X-ray penetrating the fuel cell element unit, and a computer tomography that reconstructs tormogram that is detected by the image detector to a three dimension. Preferably, the fuel cell element unit is rotated on the stage, X-ray is applied to the rotating unit to gain the tomogram thereof, and the tomogram is reconstructed to be a three-dimensional image through a computerized tomography (CT scanning) such that the pinhole formed within the unit can be effectively detected.

### CROSS-REFERENCE TO RELATED APPLICATION

The present application is a continuation in part of U.S. application Ser. No. 12/815,320, filed on Jun. 14, 2010, which claims under 35 U.S.C. §119(a) priority to and the benefit of Korean Patent Application No. 10-2009-0115265 filed in the Korean Intellectual Property Office on Nov. 26, 2009. Each of the aforementioned patent applications are hereby incorporated by reference in their entirety.

### BACKGROUND OF THE INVENTION

(a) Field of the Invention

The present invention relates to a pinhole detection system of a fuel cell. More particularly, the present invention relates to a pinhole detection system of a fuel cell that detects a pinhole formed inside a fuel cell stack element, especially MEAs and bipolar plates. (b) Description of the Related Art

Generally, a fuel cell system generates electrical energy from chemical energy.

A fuel cell system includes a fuel cell stack that generates electrical energy, a fuel supply system supplying fuel (hydrogen) with the fuel cell stack, an air supply system supplying oxygen of air, which is an oxidizing agent that is necessary for electro chemical reaction of the fuel cell stack, and a heat and water management system that controls the operating temperature and the moisture of the fuel cell stack.

Preferably, the fuel cell stack is made by laminating three layers of membrane-electrode assembly (MEA), two gas diffusion layers (GDL), or a bipolar plate.

However, as the MEA and the GDL are joined to improve productivity, a pinhole can be formed on an electrolyte membrane of the MEA by carbon fiber of the GDL. Further, a pinhole can be formed during pressing process for fabricating the bipolar plate.

The pinhole of the MEA and the bipolar plate generates a burning phenomenon by the chemical reaction of oxygen and hydrogen and pollution of the MEA by leakage of antifreeze, such that output performance of the fuel cell stack and durability are decreased and the fuel cell stack can be shut down.

Accordingly, there is a need in the art to inspect the fuel cell stack for a pinhole to improve the quality of the fuel cell stack. Further, there remains a need in the art to inspect a pinhole, which is formed inside the stack element.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a pinhole detection system for a fuel cell having that preferably effectively detects a pinhole that is formed within a fuel cell stack element.

A pinhole detection system of a fuel cell according to an exemplary embodiment of the present invention may include a stage on which a fuel cell element unit is suitably disposed to be detected, a drive portion that is suitably configured to move the stage so as to rotate the fuel cell element unit, a X-ray source that is suitably disposed at one side of the stage to apply X-ray to the fuel cell element unit that rotates, an image detector that suitably detects X-ray penetrating the fuel cell element unit, and a computer tomography that suitably reconstructs tormogram that is detected by the image detector to a three dimension.

Preferably, the pinhole detection system may further comprise a condense lens that is suitably disposed between the fuel cell element unit and the X-ray source, through which X-ray penetrates.

In preferred embodiments, the pinhole detection system may further comprise a filter that is suitably disposed between the fuel cell element unit and the X-ray source, through which X-ray penetrates.

In other preferred embodiments, the pinhole detection system may further comprise a zone plate that is suitably disposed between the fuel cell element unit and the X-ray source, through which X-ray penetrates.

Preferably, a minimum focus of the X-ray source may range from 0.1 to 10 μm, preferably, a capacity thereof may range from 2 to 160 kV, preferably, a target thereof may include Rh, Cr, Cu, or W, and a resolution of the image detection portion may be lower than 1 μm, and a magnification thereof may preferably range from 2000 to 15000.

According to certain preferred embodiments, a vacuum rate inside a discharge pipe of the X-ray source may be below 10⁻⁷ torr.

According to other certain preferred embodiments, a beryllium window may be used, in a case that an output capacity of the X-ray source may be under 60 kV.

As described herein, in a pinhole detection system of a fuel cell according to the present invention, the fuel cell element unit is suitably rotated on the stage, X-ray is applied to the rotating unit to gain the tomogram thereof, and the tomogram is suitably reconstructed to be a three-dimensional image through a computerized tomography (CT scanning) such that the pinhole formed within the unit can be effectively detected.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a schematic diagram of a pinhole detection system of a fuel cell according to an exemplary embodiment of the present invention.

FIG. 2 is a schematic diagram of a pinhole detection system of a fuel cell according to another exemplary embodiment of the present invention.

FIG. 3 shows a pinhole detection result according to an exemplary embodiment of the present invention.

Reference numerals set forth in the Drawings includes reference to the following elements as further discussed below:

100, 200: X-ray source

110, 240: fuel cell element unit

120, 270: image detector

130, 250: stage

140, 260: drive portion

150, 280: computer tomograph

210: filter

220: condense lens

230: zone plate

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE EMBODIMENTS

As described herein, the present invention features a pinhole detection system of a fuel cell, comprising a stage on which a fuel cell element unit is disposed, a drive portion that is configured to move the stage, a X-ray source that applies X-ray to the fuel cell element unit, an image detector that detects X-ray penetrating the fuel cell element unit, and a computer tomography unit.

In one embodiment, the drive portion is configured to move the stage so as to rotate the fuel cell element unit.

In another embodiment, the X-ray source is disposed at one side of the stage to apply X-ray to the fuel cell element unit.

In another further embodiment, the computer tomography unit reconstructs a tomogram that is detected by the image detector to a three dimensional image.

Certain exemplary embodiments of the present invention will hereinafter be described in detail with reference to the accompanying drawings.

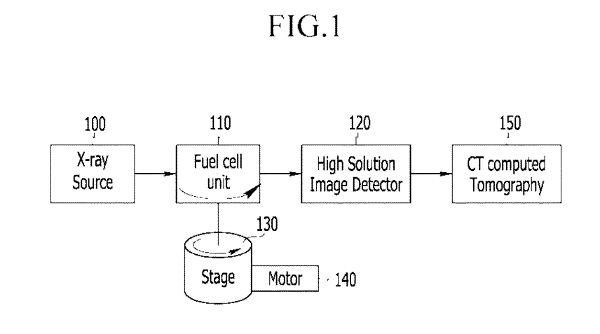

FIG. 1 is a schematic diagram of a pinhole detection system of a fuel cell according to an exemplary embodiment of the present invention.

Referring to FIG. 1, a pinhole detection system of a fuel cell preferably includes an X-ray source 100, a fuel cell element unit 110, a stage 130, a drive portion 140, an image detector 120, and a computer tomography 150 reconstructing a tomogram that is suitably detected by the image detector 120 to a three-dimensional image.

Preferably, the X-ray source 100 has a capacity ranging from 2 to 160 kV, and preferably uses Rhodium (Rh), Chrome (Cr), Copper (Cu), or Tungsten (W) as a target.

According to preferred exemplary embodiments, the fuel cell element unit 110 is three layers of membrane-electrode assembly (MEA), five layers of membrane-electrode assembly that two layers of gas diffusion layer (GDL) are pressed in a high temperature, a separating plate, or a bipolar plate.

Preferably, the fuel cell element unit 110 is suitably disposed on the stage 130, and the stage 130 rotates the fuel cell element unit 110 by the drive portion 140 such as a motor.

In certain preferred embodiments, the X-ray source 100 suitably applies X-ray to the fuel cell element unit 110 rotating, and the image detector 120 detects the X-ray penetrating the fuel cell element unit 110. In further preferred embodiments, a tomogram, which is detected by the image detector 120, is suitably reconstructed in a three-dimensional image by the computer tomograph 150 to effectively display a pinhole of the fuel cell stack element.

The method by which the image detector and the computer tomography detects and reconstructs the detected tomogram to a three-dimensional images are known to one of skill in the art, and thus a detailed description thereof is omitted.

In another exemplary embodiment of the present invention, the MEA and the GDL are suitably joined to form a configuration of five layers, wherein a pinhole can be suitably formed on an electrolyte membrane of the MEA by carbon fiber of the GDL. In further preferred embodiments, while the bipolar plate is suitably pressed to be manufactured, the pinhole can be formed therein.

Preferably, the image detector 120 effectively detects the pinhole that is suitably formed inside the fuel cell element unit 110 to improve productivity.

In another further exemplary embodiment of the present invention, minimum focus of the X-ray source 100 preferably ranges from 0.1 to 10 μm, the capacity thereof preferably ranges from 2 to 160 kV, Rh, Cr, Cu, or W is preferably used as a target, the resolution of the image detector 120 is smaller than 1 μm, and the magnification thereof preferably ranges from 2000 to 1500.

In other further embodiments, it is desirable that vacuum rate of the light radiation pipe of the X-ray source 100 is lower than 10⁻⁷ torr and that a beryllium window, which is low in absorption rate, is preferably used where the output capacity of the X-ray source 100 is under 60 kV.

Preferably, as a pinhole measure object, high molecular electrolyte membrane, catalyst, and carbon paper are suitably prepared, and laser is used to voluntarily form a pinhole of 10 to 15 μm in the electrolyte membrane—is three layer membrane electrode assembly(MEA).

Further, the GDL is hot pressed on both sides of the three layer MEA in which the pinhole is suitably formed, such that five layers MEA is fabricated.

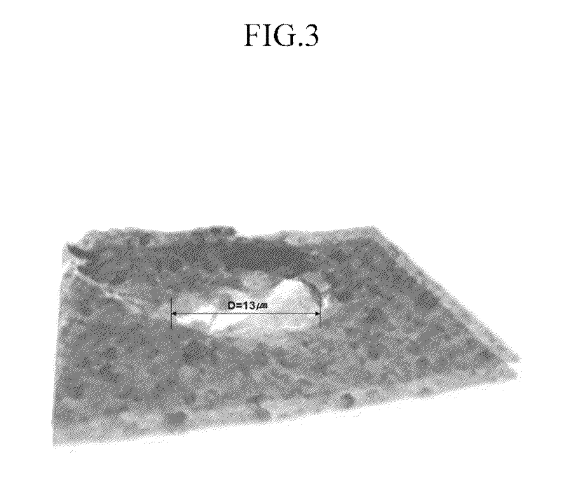

In another further embodiment, the pinhole detection system of a fuel cell is used to suitably detect a pinhole of about 13 μm. For example, FIG. 3 shows a pinhole detection result according to another exemplary embodiment of the present invention.

Preferably, the capacity of the X-ray source 100 is 5.4 kV, and Cr is used as target. Further, depending on an experimental condition or a design specification, the capacity of the X-ray source 100 and a kind of a target can be optionally varied.

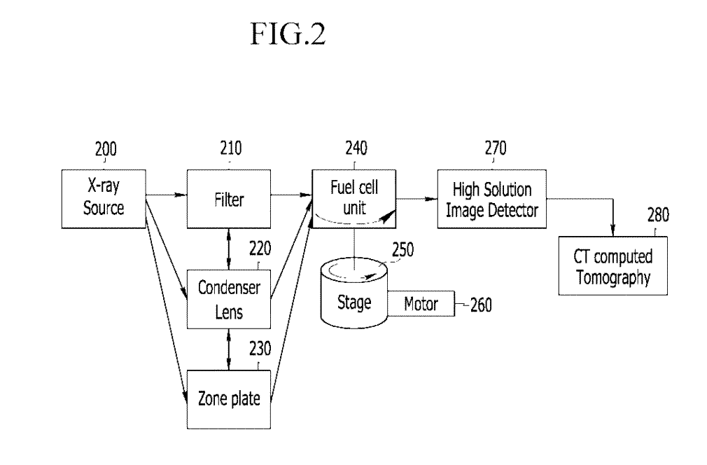

FIG. 2 is a schematic diagram of a pinhole detection system of a fuel cell according to another exemplary embodiment of the present invention.

In further exemplary embodiments and referring to FIG. 2, a pinhole detection system of a fuel cell preferably includes a X-ray source 200, a filter 210, a condense lens 220, a zone plate 230, a fuel cell element unit 240, a stage 250, a drive portion 260, an image detector 270, a computer tomograph (280, CT: computed tomography).

Preferably, the filter 210 filters a predetermined wavelength from light that is applied from the X-ray source 200, and the condense lens 220 or the zone plate 230 focuses the light generating in a predetermined area.

As described herein, the fuel cell element unit 240 is suitably disposed on the stage 250, and the stage 250 rotates the fuel cell element unit 240 by the drive portion 260.

Preferably, X-ray that is suitably generated from the X-ray source 200 is applied the fuel cell element unit 240 rotating through the filter 210, the condense lens 220, or the zone plate 230, and the image detector 270 detects the X-ray penetrating the fuel cell element unit 240.

In further preferred embodiments, the image detector 270 suitably detects the inner shape of the fuel cell element unit 240 rotating, and the computer tomograph 280 reconstructs tomogram that is detected by the image detector 270 to a three-dimensional image.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A pinhole detection system of a fuel cell, comprising:
a stage on which a fuel cell element unit is disposed to be detected;
a drive portion that is configured to move the stage so as to rotate the fuel cell element unit;
a X-ray source that is disposed at one side of the stage to apply X-ray to the fuel cell element unit that rotates;
an image detector that detects X-ray penetrating the fuel cell element unit; and
a computer tomography that reconstructs tormogram that is detected by the image detector to a three dimension.

2. The pinhole detection system of claim 1, further comprising a condense lens that is disposed between the fuel cell element unit and the X-ray source, through which X-ray penetrates.

3. The pinhole detection system of claim 1, further comprising a filter that is disposed between the fuel cell element unit and the X-ray source, through which X-ray penetrates.

4. The pinhole detection system of claim 1, further comprising a zone plate that is disposed between the fuel cell element unit and the X-ray source, through which X-ray penetrates.

5. The pinhole detection system of claim 1, wherein a minimum focus of the X-ray source ranges from 0.1 to 10 μm, a capacity thereof ranges from 2 to 160 kV, a target thereof includes Rh, Cr, Cu, or W, and a resolution of the image detection portion is lower than 1 μm, and a magnification thereof ranges from 2000 to 15000.

6. The pinhole detection system of claim 1, wherein a vacuum rate inside a discharge pipe of the X-ray source is below 10⁻⁷ torr.

7. The pinhole detection system of claim 1, wherein a beryllium window is used, in a case that an output capacity of the X-ray source is under 60 kV.

8. A pinhole detection system of a fuel cell, comprising:
a stage on which a fuel cell element unit is disposed;
a drive portion that is configured to move the stage;
a X-ray source that applies X-ray to the fuel cell element unit;
an image detector that detects X-ray penetrating the fuel cell element unit; and
a computer tomography unit.

9. The pinhole detection system of a fuel cell of claim 8, wherein the drive portion is configured to move the stage so as to rotate the fuel cell element unit.

10. The pinhole detection system of a fuel cell of claim 8, wherein the X-ray source is disposed at one side of the stage to apply X-ray to the fuel cell element unit.

11. The pinhole detection system of a fuel cell of claim 8, wherein the computer tomography unit reconstructs a tormogram that is detected by the image detector to a three dimensional image.
